(19) United States
(12) Patent Application Publication
(10) Pub. No.: US 2015/0293840 A1
(43) Pub. Date: Oct. 15, 2015

(54) MEMORY CONTROLLER AND ASSOCIATED METHOD

(71) Applicant: Realtek Semiconductor Corp., HsinChu (TW)

(72) Inventors: Cheng-Yu Chen, Hsinchu City (TW); Yu-Li Cheng, Hsinchu County (TW)

(21) Appl. No.: 14/681,099

(22) Filed: Apr. 8, 2015

(30) Foreign Application Priority Data
Apr. 9, 2014 (TW) 103113082

(51) Int. Cl. G06F 12/02

(52) U.S. Cl. CPC G06F 12/0246; G06F 2212/7201

(57) ABSTRACT

A memory controller is arranged for controlling the process of writing a page data to a memory, wherein the page data possesses a logical address. The memory controller includes a page buffer, a data pattern detector and a logical-physical address mapping table. The page buffer is used for buffering the page data. The data pattern detector is coupled to the page buffer, and used to detect whether the page data is a predetermined pattern, to generate a data pattern flag, and determine whether to write the page data to a physical address of the memory according to the data pattern flag. The logical-physical address mapping table is coupled to the data pattern detector, and is arranged for storing the data pattern flag and the logical address of the page data, and selectively generating and storing the physical address.

### BACKGROUND OF THE INVENTION

1. Field of the Invention

The disclosed embodiments of the present invention relate to a memory controller, and more particularly to a memory controller characterized by reduced memory access, and an associated memory control method.

2. Description of the Prior Art

A solid state disc (SSD) consisting of NAND flash memories has become a mainstream product due to advances in semiconductor processes and mobile technology. As the density of memory cells in an SSD continues to increase, the lifetime of the SSD will decrease. This is especially true for an SSD that utilizes multi-level cells (such as triple-level cells) instead of single-level cells (SLC).

In order to increase the lifetime of an SSD without affecting data accuracy, data management mechanisms have been used to reduce data relocation in a NAND flash. Other methods which help to uniformly access memory cells in a NAND flash or reduce the access of a NAND flash by data compression have also been discussed. Specifically, there is an urgent need for a novel memory control method which can improve issues in the prior art when hardware cost and operation speed are both important.

### SUMMARY OF THE INVENTION

One of the objectives of the present invention is to provide a memory controller characterized by reduced memory access, and an associated memory control method, to address the aforementioned issues.

According to a first aspect of the present invention, a memory controller is disclosed. The memory controller is for controlling the process of writing a page data to a memory, wherein the page data possesses a logical address. The memory controller comprises a page buffer, a data pattern detector, and a logical-physical address mapping table. The page buffer is arranged to buffer the page data. The data pattern detector is coupled to the page buffer, and arranged to detect whether the page data complies with a predetermined pattern, generate a data pattern flag, and determine whether to write the page data to a physical address of the memory according to the data pattern flag. The logical-physical address mapping table is coupled to the data pattern detector, and arranged to store the data pattern flag and the logical address of the page data, and to selectively generate and store the physical address.

According to a second aspect of the present invention, a memory controller is disclosed. The memory controller is for controlling the process of reading a page data from a memory, wherein the page data possesses a logical address. The memory controller comprises a logical-physical address mapping table, a data pattern generator and a page buffer. The logical-physical address mapping table is arranged to output a data pattern flag stored therein according to the logical address, and to selectively output a physical address stored therein according to the logical address, wherein the data pattern flag is used to indicate whether the page data complies with a predetermined pattern. The data pattern generator is coupled to the page buffer, and arranged to detect whether the page data complies with a predetermined pattern, and to selectively generate the page data or read the page data from the physical address of the memory according to the data pattern flag. The page buffer is coupled to the data pattern generator, and arranged to buffer and output the page data.

According to a third aspect of the present invention, a memory control method is disclosed. The memory control method is for controlling the process of writing a page data to a memory, wherein the page data possesses a logical address. The memory control method comprises: buffering the page data; detecting whether the page data complies with a predetermined pattern, generating a data pattern flag, and determining whether to write the page data to a physical address of the memory according to the data pattern flag; and storing the data pattern flag and the logical address of the page data, and selectively generating and storing the physical address.

According to a fourth aspect of the present invention, a memory control method is disclosed. The memory control method is for controlling the process of reading a page data from a memory, wherein the page data possesses a logical address. The memory control method comprises: outputting a data pattern flag stored therein according to the logical address, and selectively outputting a physical address stored therein according to the logical address, wherein the data pattern flag is used to indicate whether the page data complies with a predetermined pattern; selectively generating the page data or reading the page data from the physical address of the memory according to the data pattern flag; and buffering and outputting the page data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory controller according to an exemplary embodiment of the present invention.

FIG. 2 is a flowchart illustrating a memory control method according to an exemplary embodiment of the present invention.

FIG. 3 is a flowchart illustrating a memory control method according to an exemplary embodiment of the present invention.

### DETAILED DESCRIPTION

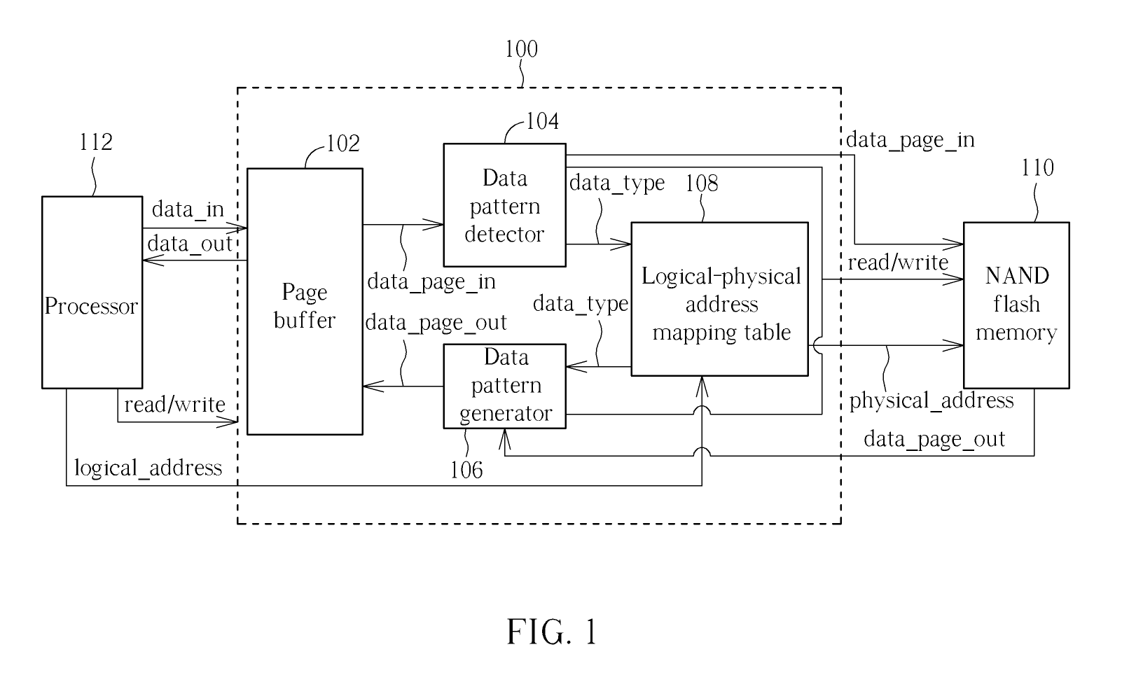

FIG. 1 is a diagram illustrating a memory controller 100 according to an exemplary embodiment of the present invention. The memory controller 100 may be operable to control a NAND flash memory 110 for a read/write operation. When data has contents of continuous logical ‘0’s or continuous logical ‘1’s, the memory controller 100 can avoid read/write operations by a simple coding scheme. The memory controller 100 and the NAND flash memory 110 may constitute a memory module, such as a solid state disk (SSD) module, a flash disk module or a portable SSD module. Moreover, the memory controller of the invention is not limited to the NAND flash memory controller. In other embodiments, the memory controller of the invention may be also operable to control other types of memory. A data transmission interface between the memory controller of the invention and an upstream processor is not limited to an input/output interface format between the memory controller 100 and a processer 112 as shown in FIG. 1. Any other interface that can achieve similar functions falls within the scope of the invention. For instance, the data transmission interface between the memory controller of the invention and the upstream processor may be a Serial Advanced Technology Attachment (SATA) interface, a Peripheral Component Interconnect Express (PCIe) interface or a Universal Serial Bus 3.0 (USB 3.0) interface.

The memory controller 100 includes a page buffer 102, a data pattern detector 104, a data pattern generator 106 and a logical-physical address mapping table 108. When the processor 112 intends to write data data_in to the NAND flash memory 110, the processor 112 utilizes a signal read/write to notify the memory controller 100, and provides a corresponding logical address logical_address of the data data_in to the memory controller 100. The memory controller 100 may be operable to write the data data_in to the page buffer 102. The size of the page buffer 102 may be designed as in conventional arts, i.e. based on the required size and speed of the NAND flash memory 110. When the data data_in is larger than the size of the page buffer 102, the write operation may be completed in several operation cycles. The data pattern detector 104 may be operable to perform data pattern detection upon a page data data_page_in buffered in the page buffer 102. When the page data has contents of all logical ‘0’s, the data pattern detector 104 may be operable to generate a page data pattern data_type=2′b01, and to store the page data pattern data_type and the corresponding logical address logical_address in the logical-physical address mapping table 108 instead of writing the page data data_page_in to the NAND flash memory 110; when the page data has contents of all logical ‘1’s, the data pattern detector 104 may be operable to generate a page data pattern data_type=2′b10, and to store the page data pattern data_type and the corresponding logical address logical_address in the logical-physical address mapping table 108 instead of writing the page data data_page_in to the NAND flash memory 110; when the page data has contents of normal data (i.e. not all logical ‘0’s or all logical ‘1’s), the data pattern detector 104 may be operable to generate a page data pattern data_type=2′b00, to store the page data pattern data_type and the corresponding logical address logical_address in the logical-physical address mapping table 108, and to write the page data data_page_in to the NAND flash memory 110.

When the processor 112 intends to read a data data_out from the NAND flash memory 110, the processor 112 utilizes the signal read/write to notify the memory controller 100, and provide the corresponding logical address logical_address of the data data_out to the memory controller 100. The logical-physical address mapping table 108 of the memory controller 100 may be operable to obtain the page data pattern data_type of the involved page according to the logical address logical_address. When the page data pattern data_type is 2′b01, it can be known that the corresponding page of the data data_out has contents of all logical ‘0’s. Note that the page having contents of all logical ‘0’s was never actually written to the NAND flash memory 110, so it is unnecessary to actually read the page from the NAND flash memory 110. Instead, the data pattern generator 106 may be notified to generate the page data data_page_out having contents of all logical ‘0’s according to page data pattern data_type, and the resultant page data may be transmitted to the page buffer 102. When the page data pattern data_type is 2′b10, it can be known that the corresponding page of the data data_out having contents of all logical 1s. Note that the page having contents of all logical ‘1’s was never actually written to the NAND flash memory 110, so it is unnecessary to actually read the page from the NAND flash memory 110. Instead, the data pattern generator 106 may be notified to generate the page data data_page_out having contents of all logical ‘1’s according to page data pattern data_type, and the resultant page data may be transmitted to the page buffer 102. When the page data pattern data_type is 2′b00, it can be known that the corresponding page of the data data_out has contents of normal data (i.e. not all logical ‘0’s or all logical ‘1’s). Note that the page having contents of normal data was actually written to the NAND flash memory 110, so it needs to actually be read from the NAND flash memory 110. The logical-physical address mapping table 108 may be operable to convert the corresponding logical address logical_address of the page to a physical address, and the data pattern generator 106 may be operable to read the page data data_page_out from the NAND flash memory 110 and transmit the page data data_page_out to the page buffer 102.

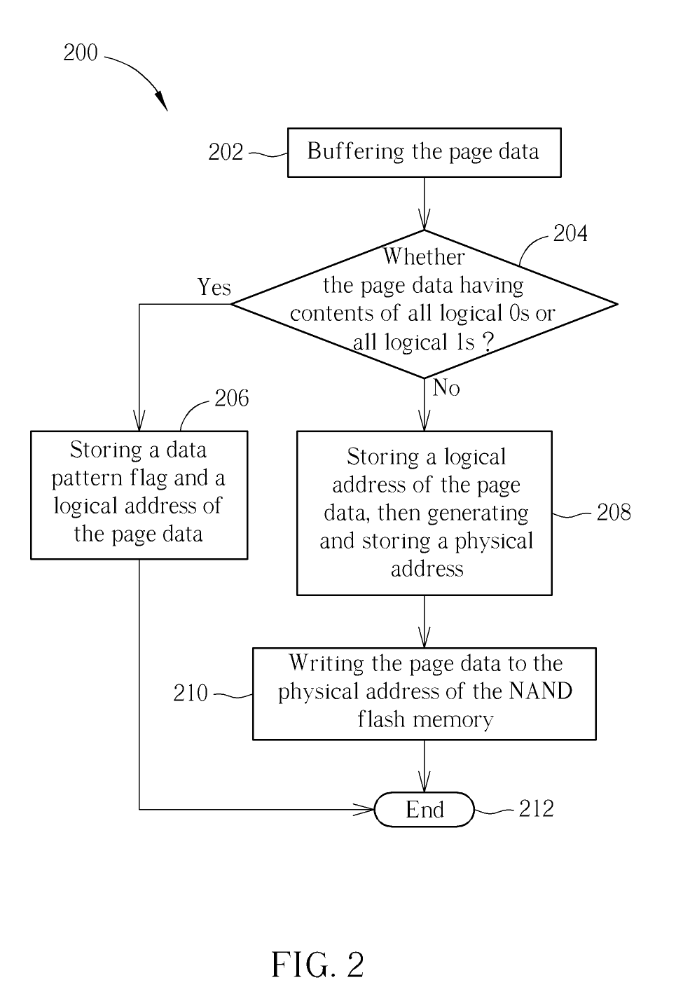

FIG. 2 is a flowchart illustrating a memory control method 200 according to an exemplary embodiment of the present invention. The memory control method 200 is for controlling the process of writing a page data to a NAND flash memory, wherein the page data possesses a logical address. The memory control method 200 may be applied to the memory controller 100 mentioned above. Provided that substantially the same result is achieved, the steps of the flowchart shown in FIG. 2 need not be in the exact order shown and need not be contiguous; that is, other steps can be intermediate. Some steps in FIG. 2 may be omitted according to various embodiments or requirements. The memory control method 200 is briefly summarized as follows.

Step S202: Buffer the page data;

Step S204: Does the page data have contents of all logical ‘0’s or all logical ‘1’s? If yes, go to step S206; else go to step S208;

Step S206: Store a data pattern flag and a logical address of the page data, and go to step S212;

Step S208: Store a logical address of the page data, then generate and store a physical address;

Step S210: Write the page data to the physical address of the NAND flash memory; and

Step S212: End.

Those skilled in the art will readily understand the steps of the memory control method 200 shown in FIG. 2 after reading the above paragraphs regarding FIG. 1; further description is therefore omitted here for brevity.

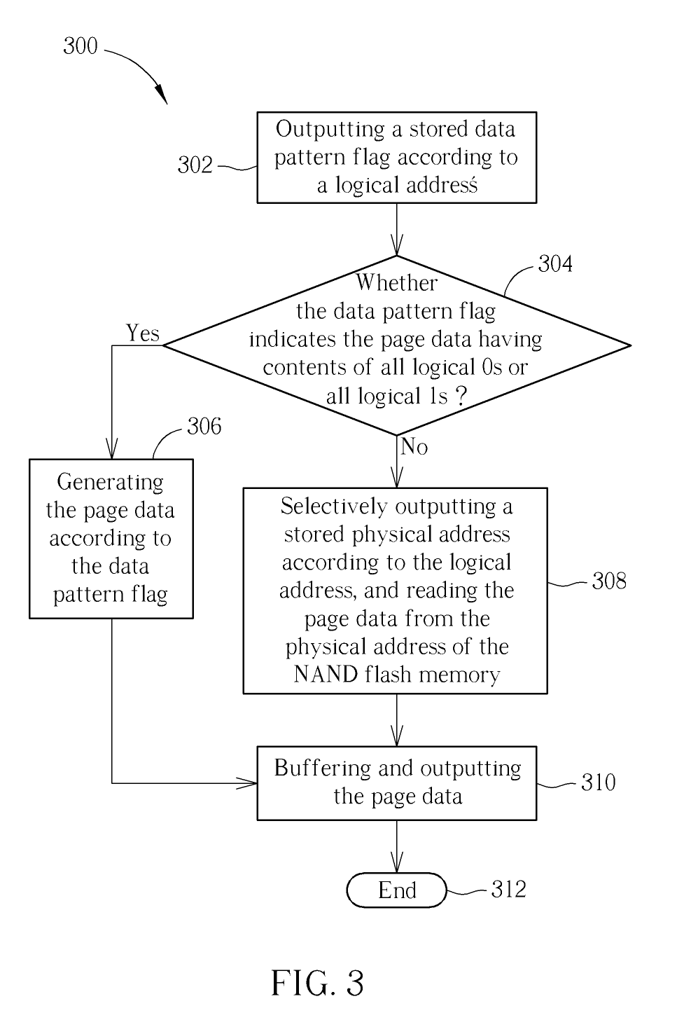

FIG. 3 is a flowchart illustrating a memory control method 300 according to an exemplary embodiment of the present invention. The memory control method 300 is for controlling the process of reading a page data from a NAND flash memory, wherein the page data possesses a logical address. The memory control method 300 may be applied to the memory controller 100 mentioned above. Provided that substantially the same result is achieved, the steps of the flowchart shown in FIG. 3 need not be in the exact order shown and need not be contiguous; that is, other steps can be intermediate. Some steps in FIG. 3 may be omitted according to various embodiments or requirements. The memory control method 300 is briefly summarized as follows.

Step S302: Output a stored data pattern flag according to a logical address;

Step S304: Does the data pattern flag indicate the page data has contents of all logical ‘0’s or all logical ‘1’s? If yes, go to step S306; else go to step S308;

Step S306: Generate the page data according to the data pattern flag, and go to step S310;

Step S308: Selectively output a stored physical address according to the logical address, and read the page data from the physical address of the NAND flash memory;

Step S310: Buffer and output the page data; and

Step S312: End.

Those skilled in the art will readily understand the steps of the memory control method 300 shown in FIG. 3 after reading the above paragraphs regarding FIG. 1; further description is therefore omitted here for brevity.

Compared to the prior art, by detecting and storing the data pattern of the page data in a page buffer, the invention may avoid direct memory access in certain circumstances. The error rate performance is not affected and the memory life time and average read/write speed are increased.

In particular, it is envisaged that the aforementioned inventive concept can be applied by a semiconductor manufacturer to any integrated circuit. It is further envisaged that a semiconductor manufacturer may employ the inventive concept in the design of a stand-alone device, or application-specific integrated circuit (ASIC) and/or any other sub-system element.

Aspects of the invention may be implemented in any suitable form including hardware, software, firmware or any combination of these. The invention may be implemented, at least partly, as computer software running on one or more data processors and/or digital signal processors or configurable module components such as FPGA devices. Thus, the elements and components of an embodiment of the invention may be physically, functionally and logically implemented in any suitable way. The functionality may be implemented in a single unit, in a plurality of units or as part of other functional units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor or controller. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Thus, an improved memory controller and associated methods have been described, wherein the aforementioned disadvantages of prior art arrangements have been substantially alleviated.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory controller, for controlling the process of writing a page data to a memory, wherein the page data possesses a logical address, and the memory controller comprises:
a page buffer, arranged to buffer the page data;
a data pattern detector, coupled to the page buffer, arranged to detect whether the page data complies with a predetermined pattern, generate a data pattern flag, and determine whether to write the page data to a physical address of the memory according to the data pattern flag; and
a logical-physical address mapping table, coupled to the data pattern detector, arranged to store the data pattern flag and the logical address of the page data, and to selectively generate and store the physical address.

2. The memory controller of claim 1, wherein the memory is a NAND flash memory.

3. The memory controller of claim 1, wherein the predetermined pattern is a page data having contents of all logical ‘0’s or all logical ‘1’s.

4. The memory controller of claim 1, wherein when the data pattern flag indicates the page data complies with the predetermined pattern, the data pattern detector does not write the page data to the memory.

5. The memory controller of claim 1, wherein when the data pattern flag indicates the page data complies with the predetermined pattern, the logical-physical address mapping table does not generate and store the physical address.

6. A memory controller, for controlling the process of reading a page data from a memory, wherein the page data possesses a logical address, and the memory controller comprises:
a logical-physical address mapping table, arranged to output a data pattern flag stored therein according to the logical address, and to selectively output a physical address stored therein according to the logical address, wherein the data pattern flag is used to indicate whether the page data complies with a predetermined pattern;
a data pattern generator, coupled to the page buffer, arranged to detect whether the page data complies with a predetermined pattern, and to selectively generate the page data or read the page data from the physical address of the memory according to the data pattern flag; and
a page buffer, coupled to the data pattern generator, arranged to buffer and output the page data.

7. The memory controller of claim 6, wherein the memory is a NAND flash memory.

8. The memory controller of claim 6, wherein the predetermined pattern is a page data having contents of all logical ‘0’s or all logical ‘1’s.

9. The memory controller of claim 6, wherein when the data pattern flag indicates the page data complies with the predetermined pattern, the logical-physical address mapping table outputs the data pattern flag stored therein according to the logical address, and does not output the physical address.

10. The memory controller of claim 6, wherein when the data pattern flag indicates the page data complies with the predetermined pattern, the data pattern detector generates the page data according to the data pattern flag.

11. A memory control method, for controlling the process of writing a page data to a memory, wherein the page data possesses a logical address, and the memory control method comprises:
buffering the page data;
detecting whether the page data complies with a predetermined pattern, generating a data pattern flag, and determining whether to write the page data to a physical address of the memory according to the data pattern flag; and
storing the data pattern flag and the logical address of the page data, and selectively generating and storing the physical address.

12. The memory control method of claim 11, wherein the memory is a NAND flash memory.

13. The memory control method of claim 11, wherein the predetermined pattern is a page data having contents of all logical ‘0’s or all logical ‘1’s.

14. The memory control method of claim 11, wherein the step of detecting whether the page data complies with the predetermined pattern, generating the data pattern flag, and determining whether to write the page data to the physical address of the memory according to the data pattern flag comprises:
when it is detected that the page data complies with the predetermined pattern, not writing the page data to the memory.

15. The memory control method of claim 11, wherein the step of detecting whether the page data complies with the predetermined pattern, generating the data pattern flag, and determining whether to write the page data to the physical address of the memory according to the data pattern flag comprises:
when it is detected that the page data complies with the predetermined pattern, not generating and storing the physical address.

16. A memory control method, for controlling the process of reading a page data from a memory, wherein the page data possesses a logical address, and the memory control method comprises:
outputting a data pattern flag stored therein according to the logical address, and selectively outputting a physical address stored therein according to the logical address, wherein the data pattern flag is used to indicate whether the page data complies with a predetermined pattern;
selectively generating the page data or reading the page data from the physical address of the memory according to the data pattern flag; and
buffering and outputting the page data.
